(19) United States
(12) Patent Application Publication
(10) Pub. No.: US 2026/0208974 A1
(43) Pub. Date: Jul. 23, 2026

(54) ROBOTIC MERGE INDUCTION

(71) Applicant: Dexterity, Inc., Redwood City, CA (US)

(72) Inventors: Parker Christensen, Redwood City, CA (US); Syed Taha Haider, Redwood City, CA (US); Samir Menon, Atherton, CA (US); Younes Achkire, San Francisco, CA (US)

(21) Appl. No.: 19/205,547

(22) Filed: May 12, 2025

Related U.S. Application Data
(60) Provisional application No. 63/747,780, filed on Jan. 21, 2025.

(51) Int. Cl. B65G 47/68; B07C 1/04; B25J 9/00; B65G 47/90; B65G 47/96

(52) U.S. Cl. CPC B65G 47/681; B25J 9/0093; B65G 47/90; B65G 47/96; B07C 1/04; B65G 2203/0216; B65G 2203/041

(57) ABSTRACT

A robotic merge induction system is disclosed. The system includes a plurality of robotic induction stations, each comprising one or more robots, each robot being configured to pick items from a pick area associated with the station with which the robot is associated and place each item in a placement location on a robotically controlled injection conveyance structure associated with the station; and a processor configured to control the robotically controlled injection conveyance structure to inject each item placed on the robotically controlled injection conveyance structure onto a downstream conveyance structure that is common to the plurality of robotic induction stations.

### CROSS REFERENCE TO OTHER APPLICATIONS

This application claims priority to U.S. Provisional Ser. No. 63/747,780 entitled ROBOTIC MERGE INDUCTION filed Jan. 21, 2025 which is incorporated herein by reference for all purposes.

### BACKGROUND OF THE INVENTION

Semi-autonomous handling of mixed parcels at a high rate (>1000 per hour) traditionally requires the use of a series of many conveyor belts and sensors (e.g., cameras), deployed over a large physical space. This approach requires significant square footage, complex control systems, and humans in-the-loop. Examples of tasks traditional conveyor technologies accomplish with this setup include the following: Bulk Flow, De-shingling, Singulation, Alignment, Gapping, Scanning, Flat Transfer, Induction, and Sortation.

### BRIEF DESCRIPTION OF THE DRAWINGS

Various embodiments of the invention are disclosed in the following detailed description and the accompanying drawings.

FIG. 1 is a diagram illustrating an embodiment of a robotic induction system. In the example shown,

FIG. 2 is a diagram illustrating an embodiment of a robotic merge induction system.

FIG. 3 is a diagram illustrating an embodiment of a robotic merge induction system.

FIG. 4 is a flow diagram illustrating an embodiment of a robotic injection process used in various embodiments of a robotic merge induction system.

FIG. 5 is a flow diagram illustrating an embodiment of a multidirectional routing process used in various embodiments of a robotic merge induction system.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Techniques are disclosed to increase the throughput for semi-autonomous robotic handling of mixed parcels for a given footprint via robotic merge induction. In various embodiments, the primary tasks of mixed parcel handling at a high rate are accomplished via a new combination of robotics, machine vision, and robotically controlled conveyance arranged within a small footprint and operating at a high rate (>2000 parcels per hour or more).

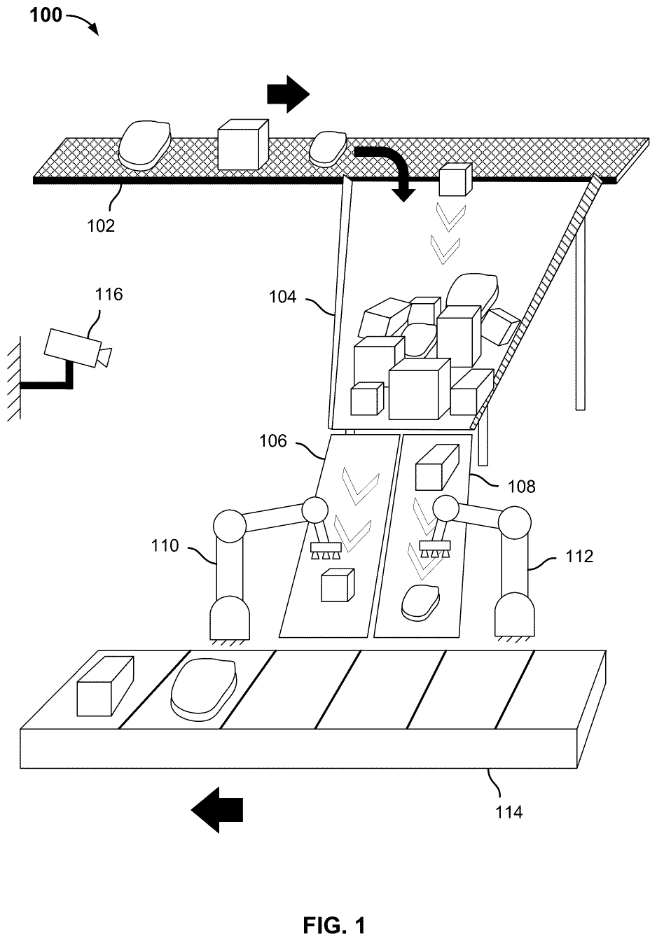

FIG. 1 is a diagram illustrating an embodiment of a robotic induction system. In the example shown, robotic induction system 100 includes a bulk flow conveyor 102 which is fed at a source or originating end, not shown in FIG. 1, and which carries parcels to feed one or more robotic induction stations, such as the robotic induction station supplied by chute 104. For example, a diverter or other structure not shown in FIG. 1 may divert parcels into chute 104. The parcels may be carried by gravity, a conveyor, and/or other forces or mechanisms to the lower end of chute 104, from which robotically controlled infeed transfer conveyors 106, 108 may convey them to a pick location for robotic arms 110, 112. Robotic arms 110, 112 pick items from the infeed transfer conveyors 106, 108 and place each item singly on a corresponding location on output conveyor 114, which in various embodiments may comprise a conveyor segmented by dividers, markers, or other structures and/or a “tilt tray” or tilt bin type of segmented conveyor, in which each item is placed singly in a tilt tray or bin which is configure to eject the item at a downstream location, e.g., by tilting and dumping the item onto a downstream chute, conveyor, or other structure associated with a destination to which the parcel is to be sent or delivered.

In the example shown in FIG. 1, one or more cameras, e.g., camera 116, may be positioned in the vicinity of the robotic induction station and may be used by one or more robotic controllers and/or control computers to estimate and continually update the state of one or more of the flow or pile of items in chute 104; the position and orientation of items on infeed conveyors 106, 108; and the availability status and trajectory over time of trays or other locations on segmented conveyor 114.

In various embodiments, conveyor 114 may carry items downstream (off the page to the left as shown in FIG. 1). A scanner tunnel or other scanner array may be used to read labels or other data visible on a parcel, and may be used downstream to route a parcel to a destination, such as a city, locale, distribution center, etc. that services a delivery location to which it is addressed.

In typical prior approaches, one or more robots operated at a station, such as the robotic induction station shown in FIG. 1, each robot picking from an associated pick area and placing each item singly at a destination, such as a tilt tray or other structure on a segmented or similar conveyor, such as conveyor 114 of FIG. 1. Computer vision using image data from one or more cameras, such as camera 116, may be used to form a view of items arriving via the bulk intake chute 104 and feed conveyors 106, 108. The view is used to determine and implement strategies to use the robotic arms to pick items singly, each from its corresponding feed conveyor 106, 108 in the example shown in FIG. 1, and place each item singly in a tilt tray or other segment on the segmented conveyor 114.

In various embodiments, induction by the robotic arms 110, 112 and injection/insertion onto the segmented conveyor enables downstream routing/sortation to be performed. For example, shipping labels or other data on an item may be read and used to route an item in a given tilt tray or segment.

However, using a robotic induction/singulation system as shown in FIG. 1 to place items directly on a segmented conveyor, such as conveyor 114, may have disadvantages. If many stations are required to achieve desired overall throughput, then the amount of space required and system integration work to be performed may be prohibitive, time consuming, and/or expensive. Further, human operators may need to be provided at each station to enable items rejected as not suitable for handling by the sortation system, e.g., because they are too heavy and/or too large, to be removed and handled separately and/or to provide for further processing of items that cannot be scanned or scanned completely enough to perform sortation.

In various embodiments, a robotic system as disclosed herein achieves higher throughput with high accuracy by using multiple robotic stations, such as the two robot station shown in FIG. 1, to induct items (e.g., boxes, flats/envelopes, polybags, etc.) from a bulk flow or other source of intake to an intermediate structure, as opposed to directly placing the items singly directly onto a tilt tray or other segmented conveyance structure.

In some embodiments, the intermediate structure comprises one or more “injection” conveyors configured to inject items onto or into a tilt tray or other segment. In some embodiments, the injection conveyor incorporates and/or operates adjacent to and/or in coordination with a scanning structure, such as a three-sided or six-sided scanner, which is used to at least partly read information required for downstream sortation. Items determined to be too heavy or large or damaged or otherwise requiring separate handling may be diverted by each injection conveyor to a local and/or common destination for “rejected” item handling. Items not (fully) scanned may be redirected to a common conveyor for intervention by a downstream human (or robotic) worker, e.g., to run them through the automated system again and/or to scan them manually prior to placing them manually on the segmented conveyor, for example.

In some embodiments, the intermediate structure onto which robotic sortation stations place items is a common “collection” conveyor shared between them. The collection conveyor may carry items though a scanning tunnel. Items scanned successfully may be directed onto one or more injection conveyor for injection into/onto tilt trays or other segments. Items not scanned successfully may be routed to a human or robotic worker for further processing, e.g., as described above.

In various embodiments, one or more of the robotic induction stations, their associated intake or feed structures, and/or injection conveyors may be oriented at an acute angle to the sortation conveyor (e.g., tilt tray or other segmented conveyor), enabling the multi-level system disclosed herein to be arranged in the space that may already be defined between the bulk intake conveyance structures and sortation conveyors, e.g., from legacy manual induction operations. In some embodiments, space efficiency is enhanced by operating structures at multiple layers, e.g., by running a collection conveyor, rejection structures, or other structures common to multiple robotic induction stations in a space below other structures.

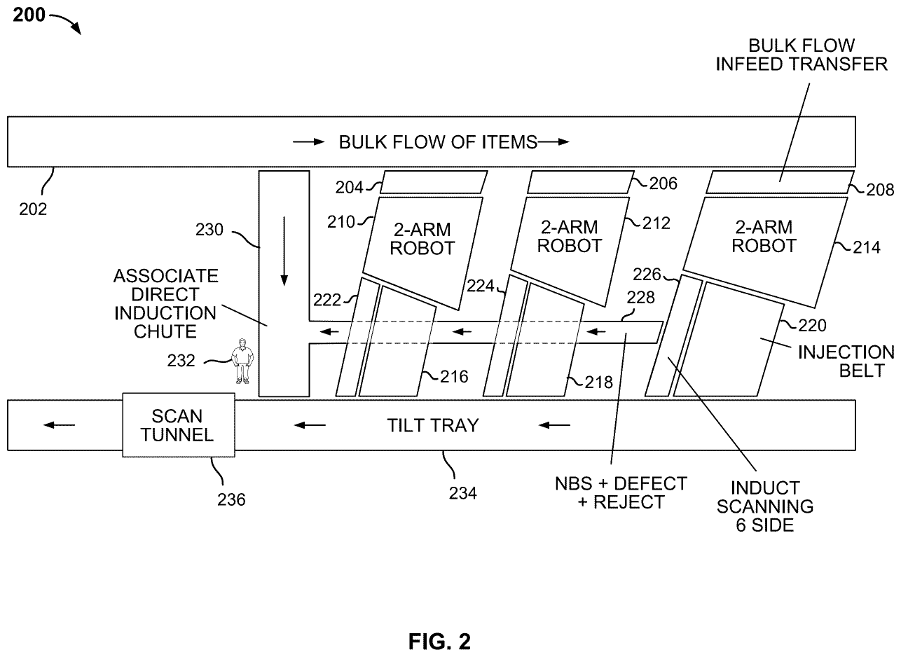

FIG. 2 is a diagram illustrating an embodiment of a robotic merge induction system. In the example shown, in system 200 parcels or other items arrive via a “bulk flow” structure 202, such as a conveyor, and feed into the respective “bulk flow intake transfer” structure(s), e.g., chutes and/or infeed conveyors 204, 206, 208, of each of three robotic induction stations 210, 212, 214, respectively. In this example, each robotic induction station includes two robots, as in the example shown in FIG. 1. Items may also be fed into a “direct induction chute” 230 for manual induction directly onto the sortation conveyance structure, i.e., the tilt tray conveyor 234 in this example, by one or more human and/or robotic workers, such as worker 232.

Each of the three robotic induction stations 210, 212, 214 in the example shown in FIG. 2 may comprise a station as shown in FIG. 1. Each robotic arm operates autonomously to place items onto its associated injection conveyor 216, 218, 220. Each set of injection conveyors incorporates a six-sided scanner 222, 224, 226. Items scanned successfully are injected onto/into a tilt tray on conveyor 234. Items requiring exception handling are routed to a downstream workstation via a conveyor 228 that runs below the injection conveyors 216, 218 for any intervening robotic induction station and delivers non-scannable, damaged, or otherwise rejected (e.g., too heavy) items to the direct induction chute 230, 232.

In various embodiments, injection conveyors (also referred to as injection belts) 216, 218, 220 are robotically controlled to inject items singly, each onto an available location on tilt tray conveyor 234. Injection may include bursts of operation of an injection conveyor 216, 218, 220, each burst timed and of a duration, speed, etc. to impart to an item on the injection conveyor 216, 218, 220 a velocity calculated to place the item on a trajectory to land and remain in a corresponding tray (or other segmented location) on tilt tray conveyor 234. Downstream, a scan tunnel 236 scans the respective item in each tray and associates the tray with a further downstream destination, to which the item is routed based on the scan. For example, the tilt tray in which the item is located may dump the item onto a downstream conveyor, chute, or other structure associated with the item's (next hop, ultimate, etc.) destination.

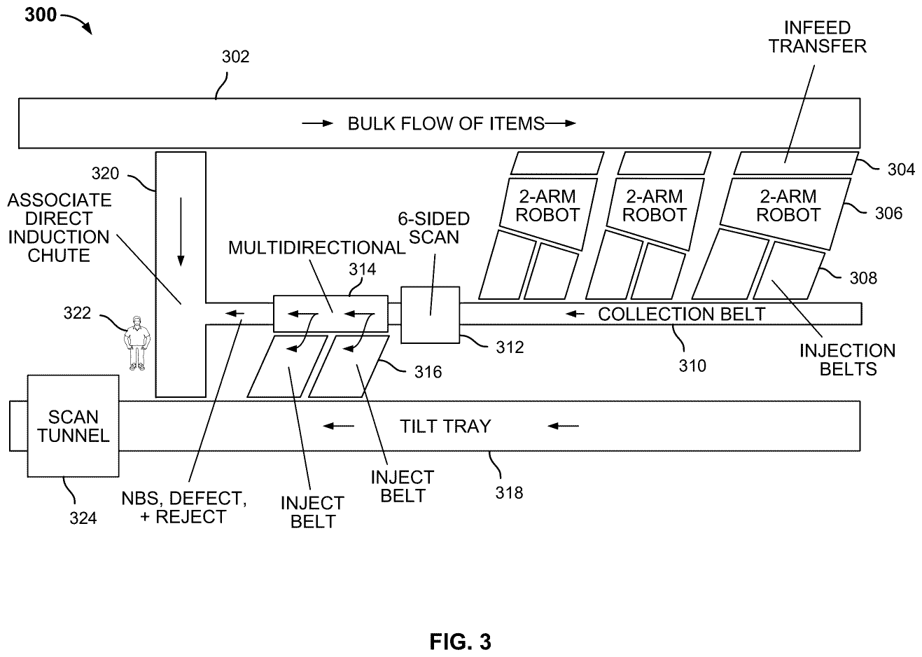

FIG. 3 is a diagram illustrating an embodiment of a robotic merge induction system. In the example shown, system 300 FIG. 3 includes a bulk flow conveyor 302 and, as in the example shown in FIG. 2, three two-robot induction stations, each including a set of infeed transfer structures 304 (e.g., chute, infeed conveyor(s)), two robotic arms 306, and a pair of injection belts 308.

Unlike the system 200 of FIG. 2, in system 300 of FIG. 3 the injection belts 308 do not inject items directly onto/into tilt trays or other segmented conveyance structures. Instead, the injection belts 308 inject items onto a common/shard collection conveyor 310. The collection conveyor 310 carries items through a six-sided scanner 312. A “multidirectional” sorter/conveyor 314 routes items that are scanned successfully onto a downstream injection conveyor 316 for injection onto/into tilt trays 318. Items not scanned successfully (i.e., “no or bad” scan or NBS), damaged items, or items otherwise not suitable for automated handling (e.g., rejected because too large and/or too heavy) are carried on to a downstream station 320 for further handling by a human 322 or other robotic worker. Items injected onto tilt tray conveyor 318 are carried through a downstream scan tunnel 324 and processed further downstream, e.g., as described above in connection with FIG. 2.

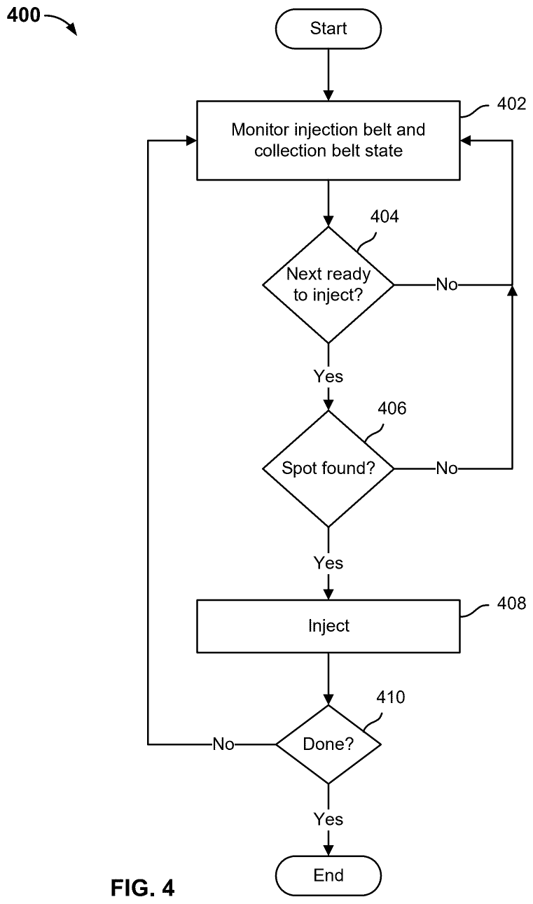

FIG. 4 is a flow diagram illustrating an embodiment of a robotic injection process used in various embodiments of a robotic merge induction system. In various embodiments, process 400 of FIG. 4 may be performed by a controller, control computer, and/or other processor to operate an injection conveyor or belt as described herein, e.g., injection conveyors 216, 218, 220 of FIG. 2 and/or injection conveyors 308 of FIG. 3. In the example shown, at 402 images or other sensor data are used to monitor one or more injection belts and the collection belt, in a system such as system 300 of FIG. 3, or the tilt tray or other segmented conveyor, in a system such as system 200 of FIG. 2. For example, the position and orientation of items on the injection belt(s) may be monitored, and available spaces on the collection belt (or segmented belt) may be identified and tracked dynamically.

If there is an item on an injection belt that is ready to be injected (404) and a spot is available on the collection (or segmented) conveyor (406), the injection belt is operated to inject the item onto the location (408). If not item is ready (404), the robotic arm may be operated to place an item onto the injection belt, or the injection belt may be advanced to place an item on the belt into a position to be injected. If an item is ready (404) but there is not immediately a location to which to inject it (406), the system may wait while continuing to monitor both the injection belt(s) and the collection (or segmented) belt (402, 404, 406).

Processing continues until all items have been injected (410), upon which process 400 ends.

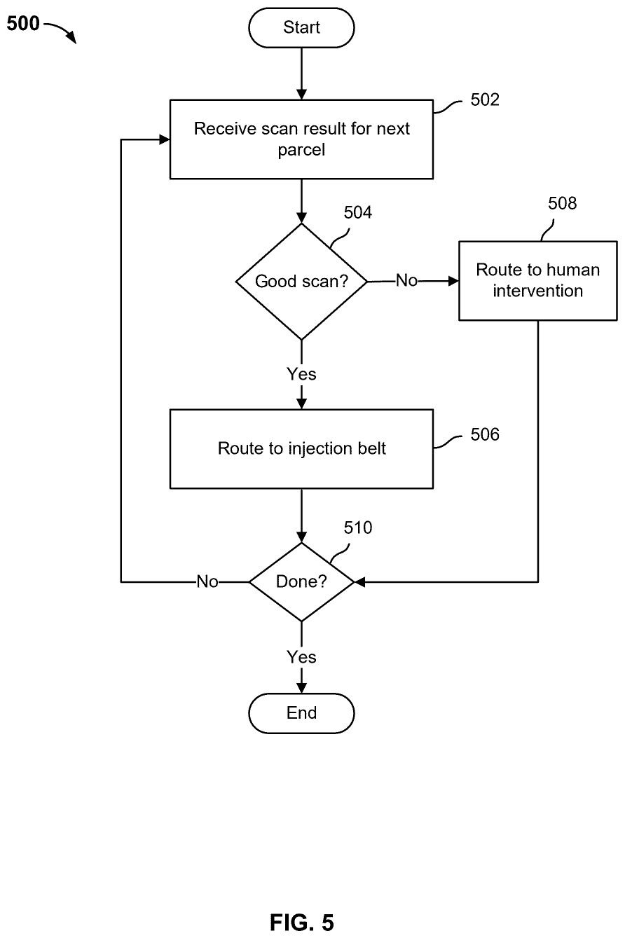

FIG. 5 is a flow diagram illustrating an embodiment of a multidirectional routing process used in various embodiments of a robotic merge induction system. In various embodiments, process 500 of FIG. 5 may be performed by a processor comprising a scanner/multidirectional router, such as multidirectional router 314 of FIG. 3. In the example shown, at 502 a next scan result is received for a parcel in the scanner/router. If the scan is a good scan (504), e.g., the information required to identify and determine the downstream routing for the parcel was fully read, then at 506 the parcel is routed to an injection belt for injection onto the tilt tray or other segmented conveyor, e.g., injection belts 316 of FIG. 3. If the scan is not a good scan (504), then at 508 the parcel is instead routed to the direct induction path for human-assisted induction, e.g., direct induction chute 320 of FIG. 3.

Processing continues until all items have been scanned and routed (510), upon which process 500 ends.

In various embodiments, techniques disclosed herein may be used to decouple robotic induction from autonomous injection of items onto/into tilt trays or other segmented structures, enabling throughput to be maximized. Full or partial scanning may be performed at the site of induction/injection, ensuring accurate and efficient operation of downstream sortation/routing structures. Items that are not suitable for automated processing and/or may require reprocessing may be handled efficiently, e.g., at a single station associated with multiple robotic induction stations, using human workers efficiently and conserving floor space.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A robotic system, comprising:
a plurality of robotic induction stations, each comprising one or more robots, each robot being configured to pick items from a pick area associated with the station with which the robot is associated and place each item in a placement location on a robotically controlled injection conveyance structure associated with the station; and
a processor configured to control the robotically controlled injection conveyance structure to inject each item placed on the robotically controlled injection conveyance structure onto a downstream conveyance structure that is common to the plurality of robotic induction stations.

2. The system of claim 1, wherein each of at least a subset of the plurality of robotic stations includes two robotic arms.

3. The system of claim 2, wherein each robotic arm has a corresponding dedicated robotically controlled injection conveyance structure.

4. The system of claim 1, wherein the robotically controlled injection conveyance structure comprises an injection belt.

5. The system of claim 1, wherein each of the robotic induction stations further includes an infeed transfer subsystem configured to transfer items from a bulk flow of items to the pick area associated with the station.

6. The system of claim 1, wherein the processor is configured to control the robotically controlled injection conveyance structure based at least in part on image or other sensor data generated by a camera or other sensor in a workspace in which the robotic system is deployed.

7. The system of claim 6, wherein the processor uses the image or other sensor data to identify an available location on the downstream conveyance structure and to control the robotically controlled injection conveyance structure to inject a given item onto the downstream conveyance structure at the identified available location.

8. The system of claim 1, wherein the downstream conveyance structure comprises a segmented conveyance structure.

9. The system of claim 8, wherein the segmented conveyance structure comprises a tilt tray conveyance structure.

10. The system of claim 1, wherein the downstream conveyance structure comprises a collection belt that collects items injected by the respective robotically controlled injection conveyance structures associated with the plurality of robotic induction stations.

11. The system of claim 10, wherein the collection belt carries items that have been placed on the collection belt through a scanner subsystem configured to scan and decode information about each item.

12. The system of claim 11, wherein the system further includes a multidirectional item routing subsystem, located downstream of the scanner subsystem, the multidirectional item routing subsystem being configured to route each item to a corresponding destination based on a scanning result generated by the scanner subsystem for that item.

13. The system of claim 12, wherein the multidirectional item routing subsystem is configured to route an item that has been scanned successfully to an injection belt configured to inject the item onto a further downstream conveyance structure.

14. The system of claim 13, wherein the further downstream conveyance structure comprises a tilt tray conveyor.

15. The system of claim 12, wherein the multidirectional item routing subsystem is configured to route an item that has not been scanned successfully to an exception handling destination.

16. The system of claim 1, wherein the exception handling destination comprises a direct induction station.

17. A method, comprising:
receiving a bulk flow of items at a plurality of robotic induction stations, each robotic induction station comprising one or more robots, each robot being configured to pick items from a pick area associated with the station with which the robot is associated and place each item in a placement location on a robotically controlled injection conveyance structure associated with the station; and
controlling the robotically controlled injection conveyance structure to inject each item placed on the robotically controlled injection conveyance structure onto a downstream conveyance structure that is common to the plurality of robotic induction stations.

18. The method of claim 17, wherein the robotically controlled injection conveyance structure comprises an injection belt.

19. The method of claim 17, wherein the downstream conveyance structure comprises a collection belt that collects items injected by the respective robotically controlled injection conveyance structures associated with the plurality of robotic induction stations.

20. A computer program product embodied in a non-transitory computer readable medium and comprising computer instructions for:
receiving a bulk flow of items at a plurality of robotic induction stations, each robotic induction station comprising one or more robots, each robot being configured to pick items from a pick area associated with the station with which the robot is associated and place each item in a placement location on a robotically controlled injection conveyance structure associated with the station; and
controlling the robotically controlled injection conveyance structure to inject each item placed on the robotically controlled injection conveyance structure onto a downstream conveyance structure that is common to the plurality of robotic induction stations.
